(19) United States
(12) Patent Application Publication
(10) Pub. No.: US 2011/0245219 A1
(43) Pub. Date: Oct. 6, 2011

(54) VIRUCIDAL DISINFECTANT

(75) Inventor: Georgios Ionidis, Zurich (CH)

(73) Assignee: ORO CLEAN CHEMIE AG, Fehraltorf (CH)

(21) Appl. No.: 13/133,996

(22) PCT Filed: Dec. 7, 2009
(86) PCT No.: PCT/CH2009/000388

§ 371 Date: Jun. 24, 2011

(30) Foreign Application Priority Data
Dec. 12, 2008 (EP) 08405302.4

(51) Int. Cl. A01N 47/28; A01N 55/02; A01N 37/02; A01N 37/04; A01P 1/00

(52) U.S. Cl. 514/184; 514/588; 514/557; 514/574

(57) ABSTRACT

A virucidal alcohol-based disinfectant, in particular for sanitary and/or surgical disinfection of hands, wherein at least one acid compound is present, is distinguished in that urea is present.

### TECHNOLOGICAL FIELD

The invention relates to an alcohol-based virucidal disinfectant, in particular for sanitary and/or surgical disinfection of hands, wherein at least one acidic compound is present. Furthermore, the invention relates to a dispenser containing a disinfectant and the use of a disinfectant for sanitary and/or surgical disinfection of hands.

### STATE OF THE ART

In recent years, disinfectants have further gained in importance. Thus in medical fields, for example in hospitals or medical practices, and also in the food and pharmaceutical industry or in places with heavy public use, such as for example in swimming pools or public toilets, disinfectants are increasingly being used on a regular basis. Thereby, people and animals can be protected against pathogens such as bacteria, fungi or viruses and the spread of the pathogens can be greatly restrained. This is of great importance, particularly with regard to the threat of pandemics.

Particularly important in this context is effective disinfection of the hands, since these are the foremost transmitters of pathogens. Rigorous hand hygiene is therefore one of the most important measures for the prevention of infections and diseases.

Effective hand hygiene consists of hand washing i.e. the reduction of germs on the skin surface by mechanical means, and disinfection, which results in the deliberate killing or harming of certain microorganisms or pathogens. Depending on the situation, it can be sufficient to carry out purely sanitary disinfection of the hands, during which the transient (transiently present on the skin) flora of the hands (mainly pathogenic germs) are eliminated. In the surgical disinfection of the hands, in order to achieve almost complete sterility, the resident (normal) flora of the hands can also be reduced, in addition to the transient flora.

Against bacteria, fungi and enveloped viruses (virus with lipoprotein envelopes) there now exists a broad spectrum of commercially available alcohol-based disinfectants. However, most of these disinfectants are only effective to a limited extent and in particular do not cover the whole spectrum of relevant viruses. In particular non-enveloped viruses, such as for example picornaviruses, are relatively stable towards individual alcohols on account of the absence of a viral envelope and accordingly are not or only insufficiently inactivated by such disinfectants. However, effective inactivation is of great importance, particularly with viruses. Thus in people and animals, viruses in very low concentrations can already lead to serious diseases, for which moreover there is often no effective treatment method.

Hence so-called virucidal disinfectants are advantageously used, which are effective both against enveloped viruses and also against non-enveloped viruses. In general here, with the alcoholic disinfectants, effectiveness against non-enveloped viruses also includes effectiveness against all enveloped viruses. According to the standard EN 14476 (2005) a disinfectant is regarded as virucidal if it is capable of inactivating the following non-enveloped viral strains under defined test conditions:
Polio virus type 1, LSc-2ab
Adenovirus type 5, strain adenoid 75, ATCC VR-5

The Guideline of the German Association for the Control of viral Diseases (DVV) inc. and the Robert Koch Institute (RKI) in the 2005 version (DVV/RKI Guideline) requires an extended test method for virucidal disinfectants, in which additional non-enveloped and also enveloped viral strains are taken into account:
Vaccinia virus, strain Elstree
Polio virus type 1, LSc-2ab
Adenovirus type 5, strain adenoid 75
Polyoma virus (SV 40), strain 777

An inactivation is said to be effective when the disinfectant is capable of decreasing the viral titer (corresponds to the content of infectious viruses present per unit volume in a cell culture lysate) of the test viral strains by at least 4 decimal logarithmic stages i.e. 4 log stages within defined exposure times. A reduction by one log stage corresponds to a tenfold or 90% reduction in the viral strains. Accordingly, a reduction by 4 log stages corresponds to a 10⁴-fold or 99.99% reduction in the viral strains. If for example 10⁶ viral strains are present initially, with a reduction by 4 log stages only 10² viral strains survive.

According to the standard EN 14476, for the disinfection of the hands, exposure times of 30 seconds, 1 minute or 3 minutes apply for the inactivation of the viral strains or the reduction of the viral strains by 4 log stages. In the DVV/RKI Guideline slightly different exposure times of 30 seconds, 1 minute, 2.5 minutes or 5 minutes (if necessary also 1.5 and 2 minutes) must be observed. For the disinfection of surfaces and instruments, e.g. medical instruments, longer exposure times apply. For practical reasons, for the disinfection of the hands exposure times which are as short as possible are desirable. Ideally, a virucidal disinfectant is capable of effecting a reduction by 4 log stages within 1 minute. With longer exposure times, there is the risk that these will not be observed by the user.

Among the test virus strains named above, the polio virus type 1, LSc-2ab in particular is highly resistant to chemicals, largely stable to acids and unaffected by lipid solvents (e.g. ethers or detergents). Alcohol-based disinfectants which are capable of inactivating the polio virus type 1, LSc-2ab are very probably also effective against the vaccinia virus, strain Elstree, the adenovirus type 5, strain adenoid 75 and the polyoma virus (SV 40), strain 777.

Hence the disinfectants classified as virucidal according to the standard EN 14476 (2005) very probably also fulfill the requirements of the DVV/RKI Guideline.

From EP 0 251 303 B1 (Krüger GmbH & Co. KG) for example a virucidal disinfectant with broad spectrum action is known, which consists of at least 70 wt. % ethanol and/or propanol and 0.5-5 wt. % of a short-chain mono, di and tricarboxylic acid or sulfaminic acid. The disinfectant displays a virus-inactivating action against the polio virus type 1, strain Mahoney. However, in comparison to the polio virus type 1, LSc-2ab, the polio virus type 1, strain Mahoney, exhibits significantly lower resistance and hence is in general easier to inactivate. Hence it is questionable whether the disinfectants of EP 0 251 303 B1 (Krüger GmbH & Co. KG) are also sufficiently effective against the polio virus type 1, LSc-2ab and fulfill the standard EN 14476 (2005) or the DVV/RKI Guideline from the year 2005.

WO 2008/049454 A1 (Ecolab Inc.) describes a disinfectant with an alcohol content of 80% or more, which in addition contains organic acids and alkoxylated mono and/or diglycerides. The disinfectant is in particular active against the polio virus type 1, LSc-2ab and fulfills the requirements of the DVV/RKI Guideline. However, disinfectants with such a high alcohol content have critical disadvantages. Thus the flash point is mostly very low, as a result of which special precautionary measures must be taken during transport, storage and use.

EP 1 685 854 A1 (B. Braun Medical AG) relates to a virucidal disinfectant with broad spectrum action, which is based on alcohol, acidic phosphorus compounds and polyalkylene glycols. The disinfectant also fulfills the requirements of the DVV/RKI Guideline, but is relatively acidic, which can cause reddening of the skin, itching or burning in the user.

In WO 91/35475 (Antiseptica Chemisch-Pharmazeutische Produkte GmbH) virucidal disinfectants for the hands are described which contain ca. 50-60 vol. % of lower alcohols and to increase the viral action are for example treated with 3-10 vol. % of diols. However, during the disinfection of the hands the diols at least partially remain on the skin and can cause an unpleasant feeling on the skin. It is not clear against which viral strains these disinfectants are effective and whether for example the standard EN 14476 (2005) or the DVV/RKI Guideline from the year 2005 are fulfilled.

Clearly the known virucidal disinfectants are not entirely satisfactory. There is thus still a need for virucidal disinfectants which do not exhibit the aforesaid disadvantages.

### DESCRIPTION OF THE INVENTION

Hence the purpose of the invention is to create a virucidal disinfectant lying within the technological field stated at the outset, which exhibits improved activity against as many different pathogens as possible and in particular is tolerated by the skin.

The solution to the problem is defined by the characteristics of claim 1. According to the invention, the virucidal disinfectant contains urea.

In this context, acidic compound or acids are understood to mean chemical compounds which in particular function as proton donors in the sense of a Brønstedt acid and/or as electrophilic electron acceptors in the form of a Lewis acid. Here the acidic compound can for example be present as an organic chemical and/or as an inorganic chemical compound, where a content of the acidic compound in the disinfectant is inter alia also determined by the acid strength or the pKₐ value. The acidic compound in particular exhibits a pKₐ value of 3-5, particularly preferably 3.5-4.0. The pKₐ value should be understood to be the negative decimal logarithm of the equilibrium constant Kₐ of the acidic compound in water at a temperature of 25° C.

A minimum content of acidic compound is preferably at least 0.1 wt. %. Such minimum contents have also proved advisable with strongly acidic compounds. However, the minimum content of acidic compound is inter alia also dependent on the acid strength of the acidic compound and can therefore vary.

In this context, urea is understood to mean carbonic acid diamide with the molecular formula CH₄N₂O. Urea, not to be confused with uric acid, is inter alia also referred to as carbamide, carbonyl diamide, diamide of carbonic acid and/or urea. In practice, a minimum content of urea is in particular at least 0.2 wt. %.

All statements relating to percentages by weight or wt. % of individual components of the disinfectants according to the invention are based on the total weight of the usable or ready to use disinfectant.

The expression “alcohol-based” means in particular that a main component of the disinfectant consists of alcohols. The main component here is in particular that component of the disinfectant which of all the components of the disinfectant present has the greatest proportion by weight.

It has surprisingly been found that disinfectants based on the combination of an alcoholic main component with at least one acidic compound and urea exhibit extremely good virucidal efficacy, in particular against the polio virus (type 1, LSc-2ab). Here the combination of the three components exhibits a considerably greater virucidal action than the individual components alone. Hence as regards virucidal action there is a positive synergistic effect. In addition, it has been found that with such disinfectants the reduction in the viral strains by 4 log stages or 99.99% reduction in the viral strains required in the aforesaid standard EN 14476 (2005) can already be achieved from an exposure time of 1 minute. With longer exposure times reductions of more than 5 log stages or more than 99.999% reductions in the viral strains are possible.

As already stated above, the polio virus type 1, LSc-2ab is a very refractory and hard to inactivate virus, since it is in particular highly resistant to chemicals, essentially acid-stable and unaffected by lipid solvents (e.g. ethers or detergents). Since the disinfectants according to the invention are capable of inactivating the polio virus type 1, LSc-2ab, they are very probably also active against the vaccinia virus, strain Elstree, the adenovirus type 5, strain adenoid 75 and the polyoma virus (SV 40), strain 777.

Furthermore, the disinfectants according to the invention have also been found to be very well tolerated by the skin. In particular through the synergistic action of the urea with the acidic compound the concentrations of these two components can be kept relatively low. Hence even with regular use of the disinfectants according to the invention over prolonged periods, skin reddening, itching, burning or the like hardly ever occur. Furthermore, on account of the composition of the disinfectant according to the invention, no residues which are unpleasant or adversely affect the feel of the skin remain on the skin.

Since urea is contained in the natural moisture retention factor of human skin, this is in principle compatible with human skin and represents no fundamental health risk.

In addition, the disinfectants according to the invention are storage-stable and thus storable relatively problem-free. Precipitation of solids and/or changes in the chemical composition or decomposition products are essentially undetectable even after several weeks. Hence there is practically no risk that in practice decomposed and no longer sufficiently effective disinfectants will be used or that undesired and in any case harmful by-products will form in the disinfectant.

The content of the alcoholic main component is advantageously at least 50 wt. % and less than 80 wt. %. A content of the alcoholic main component of at least 50 wt. % and less than 80 wt. % guarantees a virucidal action for the disinfectant, without the need for special precautionary measures during transport, storage and use. The content of the alcoholic main component is advantageously at least 60 wt. %. However, the content of the alcoholic main component is particularly preferably 65-75 wt. %.

Essentially however, the content of the alcoholic main component can also be different. Thus for example it is possible for the content of the alcoholic main component to be 80 wt. % or more. In principle, lower contents than 50 wt. % are in fact also possible, but as a result the virucidal action of the disinfectant decreases.

Particularly preferably, the content of the urea is 0.2-8 wt. %, ideally 1.75-3.25 wt. %. Such contents in particular ensure an adequate virucidal action. In addition, a urea content of at most 8% has been found to be tolerated by the skin. In principle, however, it is also possible to specify less than 0.2 wt. % urea. However, the virucidal action of the disinfectant is then lower, which can if necessary be partially compensated by increasing the content of acidic compounds. In general, however, in connection with this, the pH of the disinfectant decreases, i.e. the disinfectant becomes more acidic, which is less tolerable to the skin. In principle, urea contents of more than 8 wt. % are also possible. However, the risk of skin irritation is thereby increased. A urea content of 1.75-3.25 wt. % has been found to be optimal. Both a good virucidal action and also very good skin tolerance are thereby obtained.

Particularly preferably, at least one zinc salt is also contained. Essentially inorganic zinc salts and/or organic zinc salts, which in particular are soluble in the disinfectant, can be used. Here of course mixtures of several different zinc salts can also be used. Surprisingly it has been found that through the interaction of a zinc salt with the urea and the acidic compound an additional positive synergistic effect as regards the virucidal action of the disinfectant according to the invention is achieved. Furthermore it has been found that through the addition of zinc salts unpleasant skin odors and skin irritation are somewhat reduced.

However in principle it is also possible to use other metal salts and/or metals instead of or in addition to the zinc salt. Possible metal salts are in particular silver, lanthanum, cerium, cesium, copper and/or aluminum salts. Specific examples are NaCl, CsCl, CuCl₂ and/or CaCO₃ or sodium pyrrolidonecarboxylate. Suitable metals can for example be main group metals such as aluminum, gallium and/or indium. Likewise, transition metals such as for example scandium, yttrium, lanthanum, erbium, copper, silver, gold, cadmium and/or mercury can be used. However, these metal salts and/or metals do not contribute the same effect as the zinc salts and/or have disadvantages in other ways, such as for example poor skin tolerance.

Advantageously the at least one zinc salt comprises an organic zinc salt. Organic zinc salts have been found to be less corrosive and better tolerated by the skin than inorganic zinc salts. Inorganic zinc salts in disinfectants can be a problem even with adequate skin tolerance. Thus, if metallic instruments or devices are touched after disinfection of the hands, there is the danger that these will be corrosively attacked in the course of time. This disadvantage does not arise during the use of organic zinc salts.

Surprisingly it has also been found that urea is an excellent solubilizer for organic zinc salts in alcohols. The generally rather low solubility of organic zinc salts in solutions with high alcohol content can thus be considerably increased in interaction with urea, which in turn results in increased storage stability.

In principle, however, it is also possible to specify inorganic zinc salts instead of the organic zinc salts or together with the organic zinc salts.

Suitable organic zinc salts are non-exclusively for example zinc acetate, zinc butyrate, zinc glycolate, zinc formate, zinc lactate, zinc picolinate, zinc propanoate, zinc salicylate, zinc tartrate, zinc undecylenate, zinc ricinoleate and/or zinc pyrrolidonecarboxylate. As an inorganic zinc salt, for example ZnCl₂ can be used.

Zinc pyrrolidonecarboxylate (abbreviation: Zn PCA; molecular formula: C₅H₆NO₃Zn) has been found to be particularly advantageous as the organic zinc salt. Zinc pyrrolidonecarboxylate is the zinc salt of pyrrolidonecarboxylic acid (also called pyroglutamic acid), which as a chiral compound occurs as the L- and the D-enantiomer. It has been found that zinc pyrrolidone-carboxylate reinforces virucidal action to a high degree and nonetheless has very good skin tolerance. The latter is probably connected with the fact that the sodium salt of L-pyrrolidone-carboxylic acid, Na pyrrolidonecarboxylate (abbreviation: Na PCA), occurs as a natural moisture retention factor of human skin. Zinc pyrrolidonecarboxylate can be used alone or together with other aforesaid zinc salts, metal salts and/or metals.

A further advantageous organic zinc salt is zinc ricinoleate, which can be used instead of or in addition to zinc pyrrolidonecarboxylate, optionally with other zinc salts.

Surprisingly it has been found that the organic zinc salt can also in principle be used instead of the urea. In this case, an appropriate virucidal disinfectant has an alcoholic main component with a content of at least 50 wt. % and less than 80 wt. %, at least one acidic compound is present and at least one organic zinc salt is contained. The interaction between alcoholic main component, organic zinc salt and acidic compound here also results in a positive synergistic effect as regards the virucidal action of the disinfectant which goes beyond the virucidal action of the individual substances. Such disinfectants are also capable of already achieving the reduction in the viral strains by 4 log stages or 99.99% reduction in the viral strains required in the aforesaid standard EN 14476 (2005) beyond an exposure time of 1 minute and thus display an adequate virucidal action. Such urea-free disinfectants also have good skin tolerance.

However, disinfectants which in addition to the alcoholic main component and the acidic compound contain both urea and also organic zinc salts, are particularly preferable. In this case, the positive synergistic effect as regards the virucidal action can be additionally increased.

Preferably a content of the at least one zinc salt is 0.2-2 wt. %. Such contents optimally reinforce the virucidal action of the disinfectant. Although higher contents than 2 wt. % are in principle possible, they only further increase the virucidal action to a limited extent and are thus uneconomic. Furthermore, with contents of 2 wt. %, problems with the solubility of the zinc salts can arise. Contents of at most 2 wt. % are adequately skin tolerable even with the use of inorganic zinc salts which as a rule are relatively corrosive. At contents lower than 0.2 wt. % of zinc salt, the synergistic effect rapidly decreases, which can only to a limited extent be partly compensated by an increase in the content of acidic compounds and/or urea.

The alcoholic main component in particular consists of monohydric alcohols which advantageously have at least 2 and at most 4 carbon atoms. Preferably it is ethanol and/or 1-propanol and/or 2-propanol. Disinfectants with such alcohols, particularly in combination with the other components, have been found to be particularly suitable and effective. In a particularly preferable variant, the alcoholic main component consists of a mixture of ethanol and 2-propanol, the content of ethanol advantageously being greater than that of 2-propanol. The weight ratio of ethanol to 2-propanol ideally lies in the range from 60:10 to 80:3.

In a likewise preferred variant, the alcoholic main component consists of a mixture of ethanol and 1-propanol, the content of ethanol advantageously being greater than that of 1-propanol. The weight ratio of ethanol to 1-propanol ideally also lies in the range from 60:10 to 80:3.

In particular, the alcoholic main component can also consist of a mixture of ethanol and 1-propanol and 2-propanol, the content of ethanol advantageously being greater than that of 1-propanol and 2-propanol together.

It can however also be advantageous if the alcoholic main component consists exclusively of ethanol. In particular, this simplifies the production of the disinfectant and nonetheless ensures high virucidal action of the disinfectant. Moreover, ethanol is less problematic toxicologically than many other alcohols.

In principle, other monohydric alcohols can also be used. For example methanol, butanol and/or benzyl alcohol are possible. However, particularly owing to increased toxicity and/or lower virucidal efficacy, these examples are less advantageous. It is also possible to specify poly-hydric alcohols in the alcoholic main component in addition to or instead of the monohydric alcohols. As a result, however, the virucidal efficacy of the disinfectant may be decreased. The residues from disinfectants with polyhydric alcohols can also sometimes cause unpleasant skin sensations.

Preferably the at least one acidic compound is a non-sterilizing acidic compound. It has been found that sterilizing acidic compounds, e.g. peroxyacetic acid or peracetic acid, are usually only poorly tolerated by the skin. In this context, non-sterilizing acidic compounds are understood to be in particular carboxylic acids with a carboxy group R—COOH as the functional group, phenols, naphthols, enols (such as for example ascorbic acid), sulfates or sulfuric acid esters, sulfonic acids, thiols, phosphates or phosphoric acid esters and/or phosphoric acid.

More preferably, the disinfectant is free from peroxides. This should in particular be understood to mean that the disinfectant is free from other peroxides, apart from peroxides that are unavoidable and/or at most formed spontaneously in the disinfectant. In particular, the disinfectant overall contains less than 0.1 wt. %, preferably less than 0.01 wt. %, of peroxides. Peroxides which contain the peroxides group —O—O— have oxygen atoms in the oxidation state −1. However, the oxygen-oxygen bond of peroxides is labile in combination with the other components of the disinfectant and tends to homolytic cleavage with the formation of reactive radicals. It has been found that disinfectants containing peroxides are thus not very storage-stable and are poorly tolerated by the skin. Hence the addition of peroxides is advantageously avoided.

In particular, it is advisable to develop the disinfectant free from peroxycarboxylic acids. In particular, the disinfectant overall contains less than 0.1 wt. %, preferably less than 0.01 wt. %, of peroxycarboxylic acids. Peroxycarboxylic acids have the peroxycarboxyl group R1-COO—O—H as the functional group. It has been found that peroxycarboxylic acids, in particular peroxyacetic acid, have a powerful skin and eye irritant action in the disinfectants according to the invention and are moreover extremely labile. Hence peroxycarboxylic acids in the disinfectants according to the invention are advantageously avoided.

In principle, however, for special applications it is possible, for example to improve the virucidal action, to specify peroxides or peroxycarboxylic acids in the disinfectant. This can for example be appropriate with disinfectants which are designed for the disinfection of inanimate areas.

Advantageously the at least one acidic compound includes an organic acid, the content of the organic acid preferably being 0.2-3 wt. %. In this context, organic acids are understood in particular to mean carboxylic acids which bear a carboxyl group R—COOH. Carboxylic acids have been found to be particularly suitable examples of the acidic compounds which in combination with the alcoholic main components and the urea and/or the zinc salt increase the virucidal action of the disinfectant and at the same time result in good skin tolerance. Also, the acid strength i.e. the pKa values of carboxylic acids lie in a range which allows readily controllable metering.

In principle however it is also possible, instead of or in addition to the carboxylic acids, to specify other compounds with an acidic action. Thus in particular phenols, naphthols, enols (such as for example ascorbic acid), sulfates or sulfuric acid esters, sulfonic acids, thiols, phosphates or phosphoric acid esters and/or phosphoric acid can be used as acidic compounds. However, these acidic compounds sometimes do not display adequate virucidal action and/or they are problematic as regards health.

It is also possible to use mineral acids as acidic compounds. However, compared with the organic acids, these are as a rule very strong acids and problematic above all as regards skin tolerance.

In particular, the at least one organic acid includes lactic acid and/or glycolic acid. Preferably the acidic compound of the disinfectant comprises exclusively lactic acid and/or glycolic acid. The admixture of these two acids has been found to be very advantageous since these two organic acids as well as optimal acid strength or an optimal pKₐ value also contribute a skin-care action. The lactic acid is preferably L(+)-lactic acid, since this occurs for example in human sweat, blood and muscle serum and is moreover a component of the natural moisture retention factor of human skin.

In interaction with the lactic acid, glycolic acid or hydroxyacetic acid improves the virucidal action of the disinfectant and at the same time gives rise to skin care effects. In particular, through the addition of glycolic acid the appearance of the skin can be improved. In a further preferred embodiment, the at least one organic acid therefore comprises a mixture of lactic acid and glycolic acid, wherein the weight ratio of lactic acid to glycolic acid is in particular 1.0:1.0 to 2.0:0.2, preferably 1.3:0.7 to 1.4:0.6.

In another preferred embodiment, the at least one organic acid contains citric acid. Citric acid with the molecular formula C6H8O7 is a tricarboxylic acid with pKa values of 3.13, 4.76 and 6.4. It has been found that disinfectants containing citric acid have particularly good skin tolerance and at the same time display a good virucidal action. The citric acid here can be present instead of or in addition to glycolic acid and/or lactic acid.

In principle other organic acids are also usable, which however advantageously have pKa values in the range from 3-5. However, depending on the carboxylic acid, the skin tolerance of the disinfectant can sometimes decrease with other carboxylic acids.

It has been found that in a further preferred variant the disinfectant additionally contains at least 5 wt. % of water. More preferably it contains at least 10 wt. %, in particular at least 15 wt. %, of water. Quite especially preferably, it contains 16-25 wt. %, in particular 18-22 wt. %, of water. In particular, this better ensures that all components of the disinfectant are present essentially dissolved and homogenously distributed.

In principle however, it is also possible to dispense with water and instead of this for example to use solubilizers should these be necessary.

More preferably, the disinfectant comprises at least one additional skin care component, where as a skin care component moisturizing agents, agents for increasing the suppleness of the skin and/or vitamins are in particular present.

As additional skin care components for example one or more substances from the following group are suitable: glycerol or glycerin, propan-1,2-diol, butan-1,3-diol, sorbitol, dexpanthenol, allantoin, bisabolol, tocopheryl acetate, octyldodecanol, dodecanol, tetradecanol, hexadecanol, octadecanol, lanolin alcohol, cetearyl alcohol or cetylstearyl alcohol, cylomethicone, dimethicone, isopropyl myristate, isopropyl palmitate, cetearyl ethylhexanoate, octyl stearate, octyl octanoate, ethyl ethylhexanoate, jojoba oil, sea buckthorn oil, wool wax or lanolin, paraffin oil, vaseline, heptamethylnonane or isohexadecane, cholesterol, partial glycerides, triglycerides and alkoxylated glycerides.

Here alkoxylated monoglycerides and/or alkoxylated diglycerides have been found to be particularly advantageous as additional skin care components.

Among the vitamins, vitamin A (retinol), vitamin B2 (riboflavin), vitamin B7 (biotin) and/or vitamin B9 (folic acid) are particularly suitable. Such vitamins are good for the hair and nails, promote skin renewal and/or protect against skin inflammation.

In principle, however, additional skin care components can be dispensed with. This can be advantageous, for example for economic reasons.

Particularly preferably, glycerin, in particular with a content of 0.2-1.5 wt. %, is contained as a skin care component. Glycerin, which is also referred to as glycerine or glycerol, has been found to be an especially suitable additional skin care component, since no significant compatibility problems with the other components of the disinfectants could be observed. Moreover, disinfectants containing glycerin have a skin moisturizing action and increase the suppleness of the skin.

Here contents of 0.2-1.5 wt. % of glycerin are particularly advantageous. With lower contents than 0.2 wt. %, the effect of the glycerin decreases rapidly, while contents higher than 1.5 wt. % yield practically no additional benefit and are thus uneconomic.

In addition, an auxiliary agent for regulating the material consistency is advantageously contained. In this context, the term material consistency relates in particular to the material cohesion, adhesion, stickiness, plasticity and/or the viscosity of the disinfectant. The material consistency can for example be determined by mechanical tests known per se and/or by haptic tests, i.e. via the sense of touch. Particularly in the use of the disinfectant for the disinfection of the hands, the material consistency has a decisive effect on the skin feel, which can be important, above all with frequent and regular use.

Depending on the use purpose, different material consistencies can be advantageous. For example in the use of the disinfectant for the disinfection of the hands, very mobile and scarcely adhering disinfectants can be difficult for the user to handle, as there is the risk of uncontrolled dripping. Very viscous and strongly adhering disinfectants are less of a problem in this respect, but on the other hand require vigorous rubbing in order to achieve an even distribution of the disinfectant on all areas of the hand, which is also not optimal.

Hence regulation of the material consistency of the disinfectant is advantageous in most cases. In principle, however it is possible to dispense with additives for regulating the material consistency.

As additives for regulating the material consistency waxes and/or polymers are particularly suitable. Such compounds can be deliberately modified in their chemical structure (chain length, chemical composition, functional groups) and hence enable deliberate regulation of the material consistency of the disinfectant. Possible examples are polyethylene glycol and/or hydroxyethylcellulose. The content of additives for regulating the material consistency is dependent on the nature of the additive itself and must be adjusted depending on the desired material consistency of the disinfectant.

Polyethylene glycol has been found to be particularly advantageous as an additive for regulating the material consistency. Namely, it was surprisingly found that polyethylene glycol in the disinfectants according to the invention protects human and animal skin, particularly in the region of the hands, at least partly from the effects of the at least one acidic compound. This without significantly impairing the virucidal action of the disinfectant. Specifically, with the use of disinfectants containing polyethylene glycol, significantly less skin reddening and skin irritation occur. With other additives for regulating the material consistency, this advantage was not observed and/or the virucidal action was sometimes significantly reduced. Thus with regard to the purpose according to the invention, polyethylene glycol acts synergistically together with the alcoholic main component, the at least one acidic compound and the urea. Such disinfectants are both active against many different pathogens and also have good skin tolerance and are storage-stable long-term, i.e. over several months.

A polyethylene glycol with an average relative molecular weight of 2500-5000, in particular 3500-4500, is advantageously present as the additive for regulating the material consistency. According to generally usual nomenclature, polyethylene glycols are often designated with the expression PEG together with a numerical value which essentially corresponds to the average relative molecular weight. In this context, PEG 4000, i.e. polyethylene glycol with an average relative molecular weight of ca. 4000, has been found to be ideal. Thus PEG 4000 can be metered relatively easily and hardly impairs the virucidal action of the disinfectant. In addition, polyethylene glycols have also been found particularly suitable with regard to the aforesaid protective action relating to the at least one acidic compound.

In principle, however, polyethylene glycols with relative molecular weights of less than 2500 or more than 5000 can also be used.

Advantageously, the content of the polyethylene glycol is 0.1-5 wt. %, particularly preferably 0.5-1.5 wt. %. Such contents improve the material consistency of the disinfectant, in particular as regards the disinfection of the hands. In particular, the stickiness and the adhesion of the disinfectant thereby lie in an advantageous range. Furthermore, at such concentrations the protective action described above relating to the at least one acidic compound is ensured.

In principle, less than 0.1 wt. % or more than 5 wt. % of polyethylene glycol can also be added, should this be advantageous and/or necessary with regard to the material consistency of the disinfectant.

For regulating the viscosity it can be advantageous additionally to specify a thickener in the disinfectant. Thickeners based on crosslinked polyacrylates are for example suitable for this. A suitable thickener is for example available under the trade name Carbopol ETD 2020.

Further, at least one additional biocidal component can be present in the disinfectant. Biocidal components are active substances which are designed to destroy, deter or render harmless harmful organisms and/or to prevent damage by them, by chemical or biological means. Through the addition of additional biocidal components the efficacy of the disinfectant can be further broadened. Suitable as biocidal components in this context are in particular one or more substances which are named in the European biocide guideline 98/8/EG for applications in human hygiene:

Formaldehyde; bronopol; chlorocresol; peracetic acid; chloroxylenol; biphenyl-2-ol; hexa-2,4-dienoic acid/scorbutic acid; glutaral; clorofen; 2-phenoxyethanol; cetylpyridinium chloride; tosylchloramide sodium; sodium 2-biphenylate; phthalaldehyde; N-(3-aminopropyl)-N-dodecylpropan-1,3-diamine; troclosen sodium; sodium dichloroisocyanurate dihydrate; didecyldimethylammonium chloride; iodine; sodium hypochlorite; hydrogen peroxide; calcium hypochlorite; silver chloride; lignin; 2,2-dibromo-2-cyanoacetamide; sodium p-chloro-m-cresolate; d-gluconic acid compound with N,N″-bis(4-chlorophenyl)-3,12-diimino-2,4,11,13-tetraazatetradecanediamidine (2:1); potassium (E,E)-hexa-2,4-dienoate; quaternary ammonium compounds, benzyl-C12-18-alkyldimethyl-, chlorides; quaternary ammonium compounds, benzyl-C12-16-alkyldimethyl-, chlorides; quaternary ammonium compounds, di-C8-10-alkyldimethyl-, chlorides; pentapotassium bis(peroxymonosulfate)-bis(sulfate); quaternary ammonium compounds, benzyl-C12-14-alkyldimethyl-, chlorides; quaternary ammonium compounds, C12-14-alkyl[(ethylphenyl)methyl]dimethyl-, chlorides; quaternary ammonium compounds, [2-[[2-[(2-carboxyethyl)(2-hydroxyethyl)-amino]ethyl]amino]-2-oxoethyl]-coco alkyldimethyl-, hydroxides, internal salts; reaction products from: glutamic acid and N—(C12-14-alkyl)-propylenediamine; 6-(phthalimido)peroxyhexanoic acid; silver sodium hydrogen zirconium phosphate; poly(hexamethylendiamineguanidinium chloride); polyhexamethylene biguanide; oligo(2-(2-ethoxy)ethoxyethylguanidinium chloride) polymer; amines, n-C10-16-alkyltrimethylene di-, reaction products from chloroacetic acid; quaternary ammonium iodides; quaternary ammonium compounds (benzylalkyldimethyl(alkyl from C8-C22, saturated and unsaturated, and tallow alkyl, coco alkyl and soya alkyl), chlorides, bromides or hydroxides)/BKC; quaternary ammonium compounds (dialkyldimethyl(alkyl from C6-C18, saturated and unsaturated, and tallow alkyl, coco alkyl and soya alkyl), chlorides, bromides or methylsulfates)/DDAC; 2-butanone, peroxide; boric acid; disodium octaborate tetrahydrate; triclosan; melaleuca alternifolia, extract/Australian tea tree oil; sulfur dioxide; sodium hydrogen sulfite; disodium disulfite; sodium sulfite; potassium sulfite; dipotassium disulfite; 1-[[2-(2,4-di-chlorophenyl)-4-propyl-1,3-dioxolan-2-yl]methyl]-1H-1,2,4-triazol/propiconazole; triclocarban; dodecylguanidine monohydrochloride; silver zinc aluminum borophosphate glass/glass oxide, silver and zinc-containing; aluminum sodium silicate silver zinc complex/silver-zinc zeolite plant protection agents; sodium benzoate; disodium-tetraborate, anhydrous; mixture of cis and trans p-menthan-3,8-diol/citriodiol; mecetronium ethylsulfate; amines, C10-16-alkyldimethyl-, N-oxides; calcium dihexa-2,4-dienoate; sodium hydrogen carbonate; benzoxonium chloride; benzethonium chloride; tetradonium bromide; polyvinylpyrrolidone-iodine; silver nitrate; N,N′-(decan-1,10-diyldi-1(4H)-pyridyl-4-yliden)bis(octylammonium)dichloride; 2,4,8,10-tetra(tert-butyl)-6-hydroxy-12H-dibenzo[d,g][1,3,2]dioxaphosphocin-6-oxide, sodium-salt.

The addition of an additional biocidal component is however optional.

In addition, at least one additive from the group comprising denaturing agents, colorant agents, odor correctors, pH regulators and/or solubilizers can be present. Through such additives, the disinfectant can be further adapted to the specific requirements.

As a denaturing agent or denaturant, for example butan-2-one can be used. It is thus ensured that the disinfectant is unpalatable and not usable as an alcoholic drink.

Suitable solubilizers which improve the solubility of other substances in the disinfectant are for example hydrogenated castor oil and/or fatty alcohol alkoxylates.

Advantageously, the disinfectant contains at least one pH regulator, in order to adjust the pH of the disinfectant. As pH regulators, aminomethylpropanol (2-amino-2-methyl-propan-1-ol), monoethanolamine(2-aminoethanol) and/or triethanolamine(2-(bis(2-hydroxyethyl)amino)-ethanol) in particular are suitable. However, monoethanolamine has been found to be particularly advantageous.

Advantageously, the virucidal disinfectant is adjusted to a pH of at least 3.5, preferably at least 4.0, for example by addition of pH regulators. This is particularly advantageous during use as a disinfectant for the hands, since as a result the skin is not exposed to strongly acidic conditions.

In principle however it is also possible to specify a lower pH than 3.5. This can however be disadvantageous with regular and intensive use of the disinfectant.

The virucidal disinfectant can in principle be in a container, such as for example a bag, a can and/or a tube. It can for example be taken therefrom by the user manually.

Advantageously, however, the virucidal disinfectant is in a specially designed dispensing device, in particular an automatic dispenser and/or a spray applicator. Thereby, the virucidal disinfectant can reach the surfaces to be disinfected in a defined manner. Advantageously, the virucidal disinfectant is in an automatic dispenser, which in addition provides the user with information about the exact course of the disinfection procedure. A suitable automatic dispenser for the disinfection of the hands is for example described in the European patent application EP 07 405 271.3 (OroClean Chemie AG).

Apart from spray applicators or dispensers, products wherein the virucidal disinfectant is present on a solid carrier which is soaked or impregnated with the disinfectant have also been found to be advantageous. Particularly suitable are impregnated and/or soaked textile materials such as for example cloths, flannel or dressing material. Loose textures of fibers or threads or cotton wool can be impregnated or soaked with the virucidal disinfectants and for example used as medicinal swabs. Also possible is the use of impregnated and/or soaked papers. Solid carriers which are soaked or impregnated with disinfectants can also be in special, in particular automatic controlled dispensing devices.

The disinfectants according to the invention overall exhibit a very broad use spectrum and can be used for the disinfection of a large number of different inanimate surfaces and also of a great variety of animate surfaces. The inanimate surfaces can for example be in the form of medical instruments. The animate surfaces are in particular human and/or animal skin areas, the skin of the hands in particular being among the human skin areas.

For the production of the virucidal disinfectants according to the invention, the following procedure can for example be used: in a first process step, all components except for the alcoholic main component are completely dissolved in a suitable quantity of water.

For this, solubilizers as described above can if necessary be used. Then in a second process step, an alcoholic main component is added to the aqueous solution.

In principle, however, other production processes are also possible. Thus for example components of the disinfectant sufficiently soluble in alcohol can be dissolved beforehand in the alcoholic main component and only mixed with the aqueous solution in the second step. In principle, it is also possible to mix all components together in one process step.

Further advantageous embodiments and combinations of characteristics of the invention follow from the following detailed description and the totality of the patent claims.

### MODES OF IMPLEMENTATION OF THE INVENTION

In order to demonstrate the essence of the invention various formulae of disinfectants with different compositions were made up and their virucidal efficacy tested. For the production of the disinfectants, in a first process step, all components apart from the alcoholic main component were completely dissolved in a specified quantity of water, and in a second step the appropriate quantity of alcoholic main component was added.

The virucidal efficacy of the disinfectants thus produced was performed with polio viruses type 1, LSc-2ab as test virus in accordance with the test conditions “Sanitary hand wash disinfection and hand washing” of the standard EN 14476 (2005). In particular, the test virus i.e. polio viruses type 1, LSc-2ab was first made up in a viral suspension according to the standard at 20±1° C. Also, PBS or buffered common salt solution at 20±1° C. was used as the loading substance as specified. Further, 1 ml (milliliter) of the virus suspension and 1 ml of the buffered common salt solution were mixed with 8 ml of the virucidal disinfectant prewarmed to 20±1° C. and maintained at a test temperature of 20±1° C. After an exposure time of 60 seconds, 90 seconds and 120 seconds small volumes were withdrawn and immediately transferred into a cell maintenance medium to suppress the virucidal action. The viral titer was then determined in accordance with the standard EN 14476 (2005). The reduction of the infectivity of the viruses is calculated according to the standard from the differences in the decimal logarithmic viral titer before and after the treatment with the virucidal disinfectant.

### Examples A and B

### Virucidal Disinfectants Containing an Acidic Compound and Urea (with No Zinc Salt)

The virucidal disinfectants according to examples A and B listed in table 1 have an alcoholic main component consisting of ethanol and 2-propanol, with a content by weight of 73.07 wt. % overall. As the acidic compound or acid, in the two examples A and B, L(+)-lactic acid is contained in slightly different contents of 2.50 wt. % (Example A) and 2.00 wt. % (Example B) respectively. Furthermore, in both examples urea is contained, also in slightly different contents of 2.50 wt. % (Example A) and 3.00 wt. % (Example B) respectively. In addition, the formulae of examples A and B have PEG 4000 as an additive for regulating the material consistency, glycerin as skin care component, sodium pyrrolidonecarboxylate (Na PCA) and water.

As can be seen from table 1, with formulae according to examples A and B a viral titer reduction by 3.88 log stages (Example A) and 3.50 log stages (Example B) respectively is already achieved after 60 seconds. After 90 seconds both formulae already exhibit a viral titer reduction of more than 4 log stages and after 120 seconds with the formula according to example A, a viral titer reduction by more than 5 log stages is already achieved. Hence there is clearly a virucidal action.

In addition, the virucidal disinfectants according to examples A and B have been found to be storage-stable for at least two weeks and to have good skin tolerance. No itching, reddening or burning of the skin could be observed even after intensive use.

The virucidal disinfectants according to examples A and B can therefore be designated as suitable for use.

TABLE 1

| | Example | |
|---|---|---|
| Component | A | B |
| Alcohol [wt. %] | | |
| Ethanol | 69.39 | 69.39 |
| 2-propanol | 3.68 | 3.68 |
| Acid [wt. %] | | |
| L(+)—lactic acid | 2.50 | 2.00 |
| Glycolic acid | — | — |
| Urea [wt. %] | 2.50 | 3.00 |
| Salts [wt. %] | | |
| Zinc PCA | — | — |
| Sodium PCA | 0.25 | 0.25 |
| Skin protection [wt. %] | | |
| Glycerin | 1.00 | 1.00 |
| Additives [wt. %] | | |
| PEG 4000 | 1.00 | 1.00 |
| Rest [wt. %] | | |
| Water | 19.68 | 19.68 |
| Viral titer reduction | | |
| [Log stages] | | |
| 60 seconds | 3.88 | 3.50 |
| 90 seconds | ≧4.38 | 4.38 |
| 120 seconds | ≧5.13 | ≧4.75 |

### Examples C and D

### Virucidal Disinfectants Containing an Acidic Compound and an Organic Zinc Salt (with No Urea)

As the essential difference from examples A and B, the virucidal disinfectants according to examples C and D listed in Table 2 have an organic zinc salt in the form of zinc pyrrolidonecarboxylate (Zn PCA) with contents of 0.25 wt. % (example C) and 0.45 wt. % (example D) respectively, instead of the urea. In addition, in the formula according to example D, the acidic compound is made up of a 2:1 mixture of L(+)-lactic acid and glycolic acid.

The virucidal disinfectants according to examples C and D exhibit a viral titer reduction of at least 3.50 log stages after 60 seconds. In example D a viral titer reduction by 4 log stages is already achieved after 90 seconds, while in example D a similar viral titer reduction arises after 120 seconds. Thus the virucidal disinfectants according to examples C and D also clearly exhibit a virucidal action.

In addition, the virucidal disinfectants according to examples C and D were also found to have good skin tolerance. Here too, no itching, reddening or burning of the skin could be observed even after intensive use.

The virucidal disinfectants according to examples C and D can therefore also be designated as suitable for use.

TABLE 2

| | Example | |
|---|---|---|
| Component | C | D |
| Alcohol [wt. %] | | |
| Ethanol | 71.22 | 71.22 |
| 2-propanol | 3.79 | 3.79 |
| Acid [wt. %] | | |
| L(+)—lactic acid | 2.00 | 1.34 |
| Glycolic acid | — | 0.66 |
| Urea [wt. %] | — | — |
| Salts [wt. %] | | |
| Zinc PCA | 0.25 | 0.45 |
| Sodium PCA | — | — |
| Skin protection [wt. %] | | |
| Glycerin | 1.00 | 1.00 |
| Additives [wt. %] | | |
| PEG 4000 | 1.00 | 1.00 |
| Rest [wt. %] | | |
| Water | 20.74 | 20.54 |
| Viral titer reduction | | |
| [Log stages] | | |
| 60 seconds | 3.50 | 3.63 |
| 90 seconds | 3.88 | 4.25 |
| 120 seconds | 4.38 | ≧4.63 |

### Examples E-M

### Virucidal Disinfectants with an Acidic Compound and Urea and an Organic Zinc Salt

The virucidal disinfectants according to examples E-M listed in Table 3, like examples A-D all have an alcoholic main component consisting of a mixture of ethanol and 2-propanol, and an acidic compound, urea and Zn PCA as the organic zinc salt. In examples E, F and H-M the acidic compound is exclusively made up of L(+)-lactic acid. In example G the acidic compound consists of a 2:1 mixture of L(+)-lactic acid and glycolic acid. In addition, the formulae of examples E-M have PEG 4000 as an additive for regulating the material consistency, glycerin as a skin care component and water.

A comparison of examples E, F and H, which essentially have an identical composition apart from the different contents of urea, shows that the content by weight of the acidic compound is advantageously selected greater than the content by weight of the uric acid. Thus example E, which has 2 wt. % L(+)-lactic acid and 0.50 wt. % urea already exhibits a viral titer reduction of 3.75 log stages after 60 seconds. Such a value is not reached after 60 seconds in example H, which with 2.50 wt. % has more urea with the same content by weight of L(+)-lactic acid. A corresponding relationship can also be discerned in a comparison of examples I-K.

If example F is compared with example G, then it becomes clear that a 2:1 mixture of L(+)-lactic acid and glycolic acid as acidic compound with the same total content of acidic compound an increased virucidal action is achievable. In Example G, which as the acidic compound has a corresponding mixture of L(+)-lactic acid and glycolic acid, after 60 seconds a viral titer reduction of 3.88 log stages is reached after 60 seconds and a viral titer reduction of ≧4.88 log stages already after 120 seconds. In contrast to this, the viral titer reduction in example F first shows a value of 4.00 log stages after 120 seconds.

Examples F, L and M and essentially have an identical composition apart from the different content of organic zinc salt or Zn PCA. A comparison of the three examples shows that an increase in the content of Zn PCA from 0.45 wt. % (example F) to 0.68 wt. % (example L) or 0.90 wt. % (example M) contributes a marked increase in the virucidal action. Namely, in examples L and M a viral titer reduction of at least 4.25 log stages is already reached after 60 seconds. In example H such a viral titer reduction does not occur even after 120 seconds.

Particular attention should be paid to examples I-M. With these formulae, viral titer reductions of at least 4.00 log stages without exception already arise after 60 seconds, as is for example required in the standard EN 14476 (2005). After 120 seconds in examples E-M without exception viral titer reductions of at least 5.00 log stages are even achieved. The especially advantageous formulae of examples I-M have ca. 73 wt. % of ethanol and 2-propanol in combination with 2.00-2.50 wt. % of L(+)-lactic acid, 2.00-3.00 wt. % of urea, 0.45-0.90 wt. % of organic zinc salt or Zn PCA, 0.50-1.00 wt. % of skin protection agent or glycerin and ca. 1.00 wt. % of additives for regulating the material consistency i.e. PEG 4000 and ca. 20.0-20.3 wt. % of water.

Furthermore, the virucidal disinfectants according to examples E-M have been found to be storage-stable for at least 2 weeks and to show good skin tolerance. No itching, reddening or burning of the skin could be observed even after intensive use.

The virucidal disinfectants according to examples E-M can therefore also be designated as suitable for use, and in addition examples I-M fulfill the viral titer reductions required in the standard EN 14476 (2005) with an exposure time of 60 seconds i.e. 1 minute.

| | Example | | | | | | | | |
|---|---|---|---|---|---|---|---|---|---|
| Component | E | F | G | H | I | J | K | L | M |
| Alcohol [wt. %] | | | | | | | | | |
| Ethanol | 70.79 | 69.32 | 69.32 | 69.32 | 69.32 | 69.32 | 69.32 | 69.39 | 69.39 |
| 2-propanol | 3.76 | 3.69 | 3.69 | 3.69 | 3.69 | 3.69 | 3.69 | 3.68 | 3.68 |
| Acid [wt. %] | | | | | | | | | |
| L(+)-lactic acid | 2.00 | 2.00 | 1.34 | 2.00 | 2.50 | 2.50 | 2.50 | 2.00 | 2.00 |
| Glycolic acid | — | — | 0.66 | — | — | — | — | — | — |
| Urea [wt. %] | 0.50 | 2.00 | 2.00 | 2.50 | 2.00 | 2.50 | 3.00 | 2.00 | 2.00 |
| Salts [wt. %] | | | | | | | | | |
| Zinc PCA | 0.45 | 0.45 | 0.45 | 0.45 | 0.45 | 0.45 | 0.45 | 0.68 | 0.90 |
| Sodium PCA | — | — | — | — | — | — | — | — | — |
| Skin protection [wt. %] | | | | | | | | | |
| Glycerin | 1.00 | 1.00 | 1.00 | 0.50 | 0.50 | 0.50 | 0.50 | 1.00 | 1.00 |
| Additives [wt. %] | | | | | | | | | |
| PEG 4000 | 1.00 | 1.00 | 1.00 | 1.00 | 1.00 | 1.00 | 1.00 | 1.00 | 1.00 |
| Rest [wt. %] | | | | | | | | | |
| Water | 20.50 | 20.54 | 20.54 | 20.54 | 20.04 | 20.04 | 20.04 | 20.25 | 20.03 |
| Viral titer reduction | | | | | | | | | |
| [Log stages] | | | | | | | | | |
| 60 seconds | 3.75 | 2.75 | 3.88 | 3.38 | 4.25 | 4.25 | 4.00 | 4.38 | 4.25 |
| 90 seconds | ≧4.38 | 3.38 | ≧4.88 | 4.38 | ≧4.63 | ≧5.25 | ≧4.50 | ≧5.38 | 5.25 |
| 120 seconds | ≧5.38 | 4.00 | ≧4.88 | 4.38 | ≧5.25 | ≧5.00 | ≧5.50 | ≧5.13 | ≧5.25 |

### Examples N-P

### Comparative Examples

For comparison purposes, table 4 contains examples N-P not according to the invention. The formula according to example N as well as 72.22 wt. % of ethanol and 3.79 wt. % of 2-propanol as the alcoholic main component also contains acidic compounds in the form of 1.34 wt. % of L(+)-lactic acid and 0.66 wt. % of glycolic acid. In addition, it contains PEG 4000 as an additive for regulating the material consistency, glycerin as a skin care component, sodium pyrrolidonecarboxylate (Na PCA) and water. However, example N contains neither urea nor a zinc salt.

Example O as well as 72.22 wt. % of ethanol and 3.79 wt. % of 2-propanol as the alcoholic main component contains 4.00 wt. % of urea and PEG 4000 as an additive for regulating the material consistency and water. However, example O contains essentially no acidic compound and no zinc salt.

Example P essentially has the same composition as example O, wherein instead of the urea in example P 1.10 wt. % of organic zinc salt or Zn PCA is present. The formula according to example P contains neither an acidic compound nor urea.

The maximal viral titer reduction after 120 seconds which is attainable with the formulae of examples N-P is about 3.69 log stages. Hence even with a long exposure time of 120 seconds none of the comparative examples N-P reaches a viral titer reduction by 4 log stages. Although the formulae according to examples N-P have good skin tolerance, they must be classified as scarcely suitable for use on account of their limited virucidal action.

TABLE 4

| | Example | | |
|---|---|---|---|
| Component | N | O | P |
| Alcohol [wt. %] | | | |
| Ethanol | 71.22 | 71.21 | 71.21 |
| 2-propanol | 3.79 | 3.79 | 3.79 |
| Acid [wt. %] | | | |
| L(+)—lactic acid | 1.34 | 0.03 | — |
| Glycolic acid | 0.66 | — | — |
| Urea [wt. %] | — | 4.00 | — |
| Salts [wt. %] | | | |
| Zinc PCA | — | — | 1.10 |
| Sodium PCA | 0.45 | — | — |
| Skin protection [wt. %] | | | |
| Glycerin | 1.00 | — | — |
| Additives [wt. %] | | | |
| PEG 4000 | 1.00 | 1.00 | 1.00 |
| Rest [wt. %] | | | |
| Water | 20.54 | 19.97 | 22.90 |
| Viral titer reduction | | | |
| factor [Log stages] | | | |
| 60 seconds | 1.69 | 1.75 | 3.06 |
| 90 seconds | 3.06 | 2.50 | 3.69 |
| 120 seconds | 3.19 | 3.13 | 3.69 |

### Examples Q-T

### Solubility Experiments

Examples Q-T (table 5) confirm that urea can act as a solubilizer for organic zinc salts in alcohols. Example Q consists of a mixture of 73 wt. % of alcohols (ethanol and 2-propanol), 2.00 wt. % of L(+)-lactic acid, 0.25 wt. % of organic zinc salt i.e. zinc PCA and the rest water. Example R has 1.34 wt. % of L(+)-lactic acid and 0.66 wt. % of glycolic acid and 0.45 wt. % of organic zinc salt i.e. zinc PCA. However the two examples Q and R contain no urea. As stated in table 5 precipitates of the organic zinc salt form 48-72 hours after the preparation of the formulae in examples Q and R.

Examples S and T as well as 73 wt. % of alcohols, 0.45 wt. % (example S) or 0.90 wt. % (example T) of organic zinc salt (zinc PCA) and water, additionally contain 2.00 wt. % of urea. With the formulae according to these examples, even after more than two weeks no changes or precipitates whatever could be observed. The generally rather low solubility of organic zinc salts in solutions with high alcohol content can thus be considerably increased in interaction with urea, which in turn results in increased storage stability.

TABLE 5

| | Example | | | |
|---|---|---|---|---|
| Component | Q | R | S | T |
| Alcohol [wt. %] | 73 | 73 | 73 | 73 |
| Acid [wt. %] | | | | |
| L(+)—lactic acid | 2.00 | 1.34 | 2.00 | 2.00 |
| Glycolic acid | — | 0.66 | — | — |
| Urea [wt. %] | — | — | 2.00 | 2.00 |
| Zinc PCA [wt. %] | 0.25 | 0.45 | 0.45 | 0.90 |
| Rest [wt. %] | | | | |
| Water | 24.75 | 24.55 | 22.55 | 22.10 |
| Stability at room | Precipi- | Precipi- | >2 | >2 |
| temperature | tation | tation | weeks | weeks |
| | after | after | stable | stable |
| | 48-72 hrs | 48-72 hrs | | |

The practical examples given above should be understood merely as illustrative examples, which can be modified at will.

So for example it is possible, instead of or in combination with urea and/or zinc salts, to use other components, such as for example substances with a denaturing action and/or chaotropic substances (substances which break hydrogen bonds). Guanidine hydrochloride and/or organic aluminum salts and/or organic silver salts can in particular be suitable for this.

Likewise it can be advantageous to use urea in combination with other types of disinfectant formulations as a solubilizer for salts and/or for intensifying the virucidal action.

In summary, it should be stressed that novel formulae for virucidal disinfectants have been found, which are distinguished by high virucidal activity and exceptionally good skin tolerance. In addition, the disinfectants according to the invention are distinguished by high storage stability and shelf life.

1-26. (canceled)

27. Alcohol-based virucidal disinfectant for sanitary and surgical disinfection of hands, wherein at least one acidic compound is present, that contains urea.

28. The virucidal disinfectant as claimed in claim 27, wherein the content of an alcoholic main component is at least 50 wt. % and less than 80 wt. %.

29. The virucidal disinfectant as claimed in claim 27, wherein it contains at least one additive for regulation of the material consistency, the at least one additive comprising a polyethylene glycol.

30. The virucidal disinfectant as claimed in claim 29, wherein the polyethylene glycol has with an average relative molecular weight in the range of 2500-5000.

31. The virucidal disinfectant as claimed in claim 29, wherein the content of the polyethylene glycol is 0.1-5 wt. %.

32. The virucidal disinfectant as claimed in claim 29, wherein the content of the polyethylene glycol is 0.5-1.5 wt. %.

33. The virucidal disinfectant as claimed in claim 27, wherein the content of the urea is 0.2-8 wt. %.

34. The virucidal disinfectant as claimed in claim 27, wherein the content of the urea is 1.75-3.25 wt. %.

35. The virucidal disinfectant as claimed in claim 27, wherein it contains at least one zinc salt.

36. The virucidal disinfectant as claimed in claim 35, wherein the at least one zinc salt includes an organic zinc salt.

37. The virucidal disinfectant as claimed in claim 35, wherein the at least one zinc salt includes zinc pyrrolidonecarboxylate.

38. The virucidal disinfectant as claimed in claim 35, wherein a content of the at least one zinc salt is 0.2-2 wt. %.

39. The virucidal disinfectant as claimed in claim 27, wherein the alcoholic main component consists of monohydric alcohols with at least 2 and at most 4 carbon atoms.

40. The virucidal disinfectant as claimed in claim 39, wherein the alcoholic main component is ethanol or 1-propanol or 2-propanol, or a mixture of at least two of this compounds.

41. The virucidal disinfectant as claimed in claim 39, wherein the alcoholic main component consists of ethanol.

42. The virucidal disinfectant as claimed in claim 27, wherein the at least one acidic compound is a non-sterilizing acidic compound.

43. The virucidal disinfectant as claimed in claim 27, wherein the disinfectant is free from peroxides and free from peroxycarboxylic acids.

44. The virucidal disinfectant as claimed in claim 27, wherein the at least one acidic compound includes an organic acid, and a content of the organic acid is 0.2-3 wt. %.

45. The virucidal disinfectant as claimed in claim 44, wherein the at least one organic acid contains lactic acid and glycolic acid.

46. The virucidal disinfectant as claimed in claim 44, wherein the at least one organic acid contains citric acid.

47. The virucidal disinfectant as claimed in claim 27, wherein it contains at least one additional skin care component, and as the additional skin care component skin moisturizing agents, agents for increasing the suppleness of the skin and vitamins are present.

48. The virucidal disinfectant as claimed in claim 47, wherein as an additional skin care component it contains glycerin at a content of 0.2-1.5 wt. %.

49. The virucidal disinfectant as claimed in claim 47, wherein as an additional skin care component it contains alkoxylated glycerides at a content of 0.2-1.5 wt. %.

50. The virucidal disinfectant as claimed in claim 27, wherein at least one additional biocidal component is present.

51. The virucidal disinfectant as claimed in claim 27, wherein at least one additive from the group comprising denaturing agents, colorant agents, odor correctors, pH regulators and solubilizers is present.

52. The virucidal disinfectant as claimed in claim 51, wherein it contains monoethanolamine as a pH regulator.

53. The virucidal disinfectant as claimed in claim 27, wherein the virucidal disinfectant has a pH of at least 3.5.

54. The virucidal disinfectant as claimed in claim 27, wherein the virucidal disinfectant has a pH of at least 4.0.

55. The virucidal disinfectant as claimed in claim 27, wherein in addition it contains at least 5 wt. % of water.

56. The virucidal disinfectant as claimed in claim 27, wherein in addition it contains at least 16-25 wt. % of water.

57. A dispensing device, a dispenser, or a spray applicator, containing a virucidal disinfectant as claimed in claim 27.

58. Use of a virucidal disinfectant as claimed in claim 27 for sanitary and surgical disinfection of hands.
